(19) United States
(12) Patent Application Publication
(10) Pub. No.: US 2026/0064562 A1
(43) Pub. Date: Mar. 5, 2026

(54) GENERATION METHOD AND INFORMATION PROCESSING APPARATUS

(71) Applicant: Fujitsu Limited, Kawasaki-shi (JP)

(72) Inventors: Yuta TERANISHI, Fukuoka (JP); Yui HIRAKAWA, Fukuoka (JP)

(73) Assignee: Fujitsu Limited, Kawasaki-shi (JP)

(21) Appl. No.: 19/291,695

(22) Filed: Aug. 6, 2025

(30) Foreign Application Priority Data
Aug. 28, 2024 (JP) 2024-146670

(51) Int. Cl. G06F 11/34; G06F 11/07

(52) U.S. Cl. CPC G06F 11/3476; G06F 11/0769

(57) ABSTRACT

A computer acquires first partial log data extracted from first log data output by an information processing system. The computer generates, by entering the first partial log data to a trained machine learning model, a search program for searching second log data for second partial log data having a common pattern with the first partial log data by using the machine learning model.

### CROSS-REFERENCE TO RELATED APPLICATION

This application is based upon and claims the benefit of priority of the prior Japanese Patent Application No. 2024-146670, filed on August 28, 2024, the entire contents of which are incorporated herein by reference.

### FIELD

The embodiments discussed herein relate to a generation method and an information processing apparatus.

### BACKGROUND

An information processing system outputs log data in which the operation status of the information processing system is recorded. The log data indicates various kinds of events such as start and stop of devices, start and stop of service processes, communications with other devices, access authentications, and occurrences of errors. In general, log data has a large size because various events are recorded. There are cases where a worker such as an administrator of an information processing system extracts a part useful for work such as failure detection or failure recovery from log data.

There is a technique for detecting an important word from an original document by using a regular expression, and for determining a translation corresponding to the important word by using a machine learning model. In addition, there is a technique for performing syntax analysis on a skill name by using a machine learning model, and for searching for an electronic document relating to the skill. See, for example, the following literatures.

Japanese Laid-open Patent Publication No. 2021-43955

International Publication Pamphlet No. WO 2022/226646

### SUMMARY

In one aspect, there is provided a non-transitory computer-readable recording medium storing therein a computer program that causes a computer to execute a process including: acquiring first partial log data extracted from first log data output by an information processing system; and generating, by entering the first partial log data to a trained machine learning model, a search program for searching second log data for second partial log data having a common pattern with the first partial log data by using the machine learning model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing apparatus according to a first embodiment;

FIG. 2 is a diagram illustrating a hardware example of an information processing apparatus according to a second embodiment;

FIG. 3 is a diagram illustrating an example of a failure report file and a log file;

FIG. 4 is a diagram illustrating an example of a flow of extraction of an important log by using a large-scale language model;

FIG. 5 is a diagram illustrating an example of the structure of the large-scale language model;

FIG. 6 is a diagram illustrating an example of a partial log file;

FIG. 7 is the first half of a diagram illustrating an example of an input text;

FIG. 8 is the second half of the diagram illustrating the example of the input text;

FIG. 9 is a diagram illustrating an example of an output text;

FIG. 10 is a block diagram illustrating a functional example of the information processing apparatus; and

FIG. 11 is a flowchart illustrating an example of a procedure of extraction of an important log.

### DESCRIPTION OF EMBODIMENTS

For example, since log data has a large size, manually extracting a part useful for a certain purpose, such as extracting an error event relating to failure recovery, from the log data places a heavy burden on an operator. To solve this, it is conceivable that a computer supports extraction of a part of the log data.

However, there are various formats of log data, and it is often a heavy programming burden to grasp a format specific to a useful part and to manually create an automatic extraction program. In addition, the log data may include a large number of situation-dependent character strings such as a device identifier and an event time. For this reason, only searching for a part similar to a partial log extracted in past work by string matching may result in low extraction accuracy.

Hereinafter, embodiments will be described with reference to the drawings.

### (a) First Embodiment

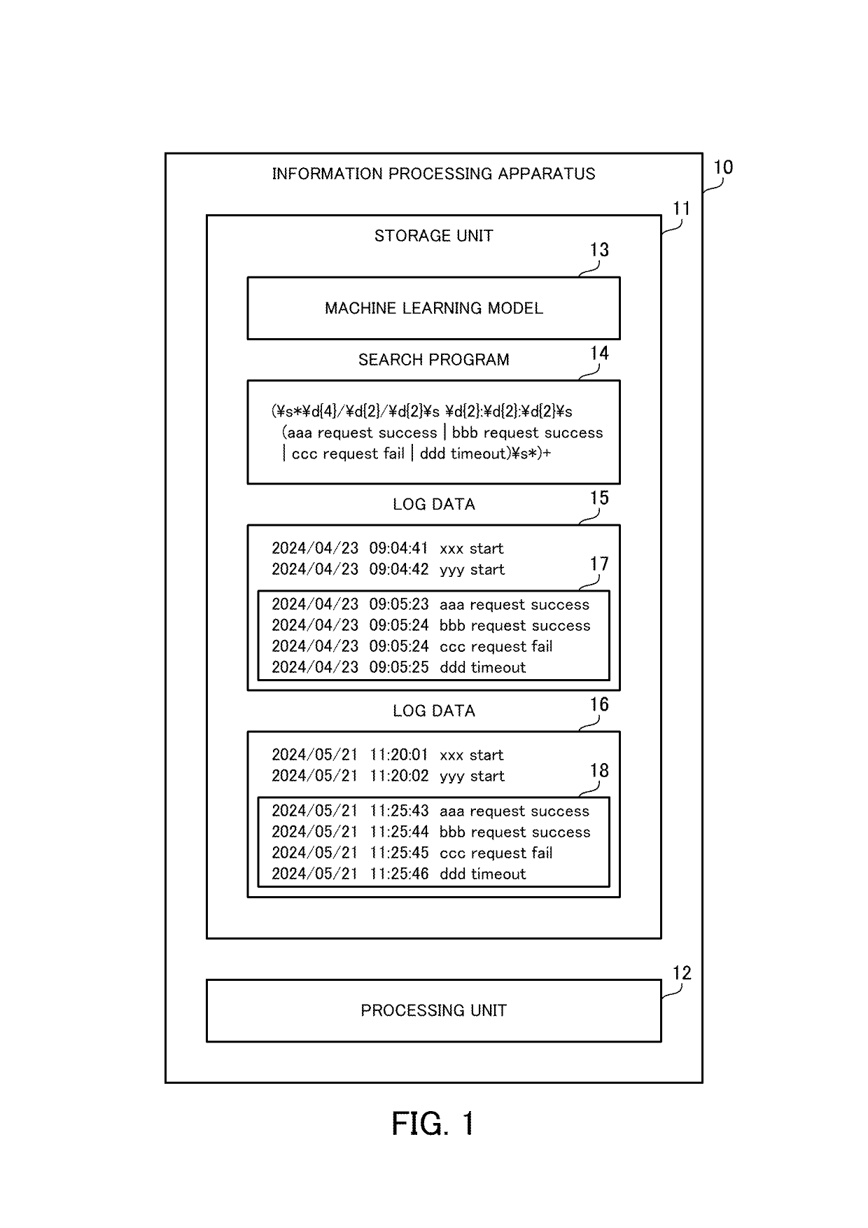

FIG. 1 is a diagram illustrating an information processing apparatus according to a first embodiment. An information processing apparatus 10 according to the first embodiment supports extraction of a useful part from log data. For example, the information processing apparatus 10 supports extraction of a part relating to a failure in the information processing system from log data. The information processing apparatus 10 may be a client apparatus or a server apparatus. The information processing apparatus 10 may be referred to as a computer or a generation apparatus.

The information processing apparatus 10 includes a storage unit 11 and a processing unit 12. The storage unit 11 may be a volatile memory such as a random access memory (RAM). Alternatively, the storage unit 11 may be a non-volatile storage such as a hard disk drive (HDD) or a solid state drive (SSD).

The processing unit 12 is, for example, a processor such as a central processing unit (CPU), a graphics processing unit (GPU), or a digital signal processor (DSP). The processing unit 12 may include an electronic circuit such as an application specific integrated circuit (ASIC) or a field programmable gate array (FPGA). The processor executes, for example, a program stored in a memory such as a RAM. The processor may be referred to as processor circuitry. A set of processors may be referred to as a multiprocessor or simply as a “processor”. Different processing steps among a plurality of processing steps described below may be executed by different processors.

The storage unit 11 stores partial log data 17. The partial log data 17 is data extracted from log data 15 output by the information processing system. The information processing system may include hardware elements such as a server computer, a client computer, a storage device, and a communication device as components. The information processing system may include software elements such as application software, middleware, an operating system (OS), an authentication process, and a monitoring process.

The log data 15 is data in which the operation status of the information processing system is recorded. Normally, the log data 15 is data having a large size. The log data 15 indicates various kinds of events that have occurred in the components of the information processing system. For example, the log data 15 indicates events such as start and stop of devices, start and stop of service processes, communications with other devices, access authentications, and occurrences of errors.

Typically, the log data 15 is described in a natural language and includes character strings in the natural language. The log data 15 may include an event occurrence time, an event type, a message briefly describing the content of the event, and the like. The log data 15 may chronologically include a plurality of records corresponding to a plurality of events. The log data 15 may be output for each component of the information processing system. Different log data output from different types of components may be described in different formats.

The partial log data 17 is a part of the log data 15, and this part has been determined to be useful for a certain purpose. The partial log data 17 may be a part that has been referred to or extracted by the user in the past. For example, the partial log data 17 is a part determined by an engineer that the part relates to a failure at the time of the occurrence of the failure in the information processing system. The partial log data 17 may be a part referred to by failure report data indicating a past failure.

The partial log data 17 may be extracted from the log data 15 and accumulated. The information processing apparatus 10 may extract the partial log data 17 from the accumulated log data 15 or may extract the partial log data 17 from data indicating past work such as failure report data. The information processing apparatus 10 may receive the partial log data 17 from the user or may receive the partial log data 17 from another information processing apparatus.

The processing unit 12 generates a search program 14 by using a trained machine learning model 13. The machine learning model 13 may be stored in the storage unit 11 or may be stored in another information processing device. In the latter case, the processing unit 12 may transmit input data to this another information processing device, and may receive output data of the machine learning model 13 from this another information processing device.

Typically, the machine learning model 13 is a natural language processing model that generates an output text including a natural language character string from an input text including a natural language character string. This natural language processing model may be referred to as a large language model (LLM). The machine learning model 13 may be a neural network having trained parameter values. The machine learning model 13 may be a recurrent neural network (RNN) or a neural network having an attention mechanism such as a transformer.

The search program 14 is a program capable of searching log data 16 different from the log data 15 for partial log data 18 having a common pattern with the partial log data 17. The log data 16 is output after the log data 15, for example. The same information processing system may output the log data 15 and 16. Alternatively, different information processing systems may output the log data 15 and 16.

Typically, the common pattern is a common character string pattern. It is also fair to say that the partial log data 18 is similar to the partial log data 17. However, the partial log data 18 may be partially different from the partial log data 17. For example, the partial log data 18 is a part of the log data 16, and in this part, a keyword indicating an event type or a format is common to that of the partial log data 17. However, the log data 15 and the log data 16 may include character strings specific to individual events, such as identifiers of components and event times. These identifiers and event times of the partial log data 18 may be different from those of the partial log data 17.

The search program 14 may be a source code represented by character strings. For example, the search program 14 includes a regular expression that defines a character string pattern. The processing unit 12 generates the search program 14 by entering the partial log data 17 to the machine learning model 13. The processing unit 12 may cause the machine learning model 13 to generate the search program 14, and may use the output of the machine learning model 13 as the search program 14. In addition to the partial log data 17, the processing unit 12 may enter an instruction for instructing generation of a search program. The processing unit 12 may generate the search program 14 by processing the output of the machine learning model 13.

The processing unit 12 may store the search program 14 in a non-volatile storage, display the search program 14 on a display device, or transmit the search program 14 to another information processing apparatus. The processing unit 12 may extract the partial log data 18 from the log data 16 by executing the search program 14. In this case, the processing unit 12 may store the partial log data 18 in a non-volatile storage, display the partial log data 18 on a display device, or transmit the partial log data 18 to another information processing apparatus.

The generated search program 14 may be used for various log data. For example, upon occurrence of one failure, the search program 14 is executed on log data of different components. Further, for example, the search program 14 is used in common upon occurrence of a plurality of failures. The search program 14 may be executed by another information processing apparatus. When the search program 14 is a regular expression itself, the search program 14 may be executed on infrastructure software for interpreting the regular expression.

As described above, the information processing apparatus 10 according to the first embodiment acquires the partial log data 17 extracted from the log data 15 output by the information processing system. The information processing apparatus 10 generates, by entering the partial log data 17 to the trained machine learning model 13, the search program 14 for searching the log data 16 for the partial log data 18 having a common pattern with the partial log data 17 by using the machine learning model 13.

In this way, the burden of the work of extracting a useful part relating to a certain purpose from the log data 16 is reduced, and the extraction of the useful part from the log data 16 is made more efficient. For example, when a failure occurs in the information processing system, a part relating to the failure is efficiently extracted.

It is also conceivable that the operator analyzes the log data 15 to understand a format specific to the partial log data 17, and manually creates the search program 14 by programming. However, since the format of the log data varies depending on the component of the information processing system, the burden of such programming is large. On the other hand, the information processing apparatus 10 is able to generate the search program 14 from the partial log data 17.

It is also conceivable that the operator enters the entire log data 16 to the machine learning model 13 and causes the machine learning model 13 to directly extract an important part in the log data 16. However, since the size of the log data 16 is large, there are cases where the machine learning model 13 does not accept the log data 16. In addition, the log data 16 may include many special words or special formats that do not appear in daily sentences, and the summarization accuracy of the machine learning model 13 may be low. On the other hand, the search program 14 is able to extract a part similar to the partial log data 17.

The operator may search the log data 16 for a part corresponding to the partial log data 17 by direct character string matching between the log data 16 and the partial log data 17. However, the log data 16 and the partial log data 17 may include character strings specific to individual events, such as identifiers of components and event times. Therefore, it is not easy to search for a part similar to the partial log data 17 by simple character string matching. On the other hand, the information processing apparatus 10 is able to generate the search program 14 for searching for a part having a pattern characteristic to the partial log data 17 by using the generalization capability of the machine learning model 13.

It is also conceivable that the operator enters the log data 16 and the partial log data 17 to the machine learning model 13 and causes the machine learning model 13 to directly extract a part similar to the partial log data 17 from the log data 16. However, there are cases where the machine learning model 13 does not accept the log data 16 and the partial log data 17 due to the limitation of the input data size. Further, calling the machine learning model 13 for each combination of log data 16 and partial log data 17 results in a large calculation amount and a long execution time. On the other hand, the search program 14 itself needs a small calculation amount and a short execution time. Once the information processing apparatus 10 generates the search program 14, the search program 14 is usable for various log data.

### (b) Second Embodiment

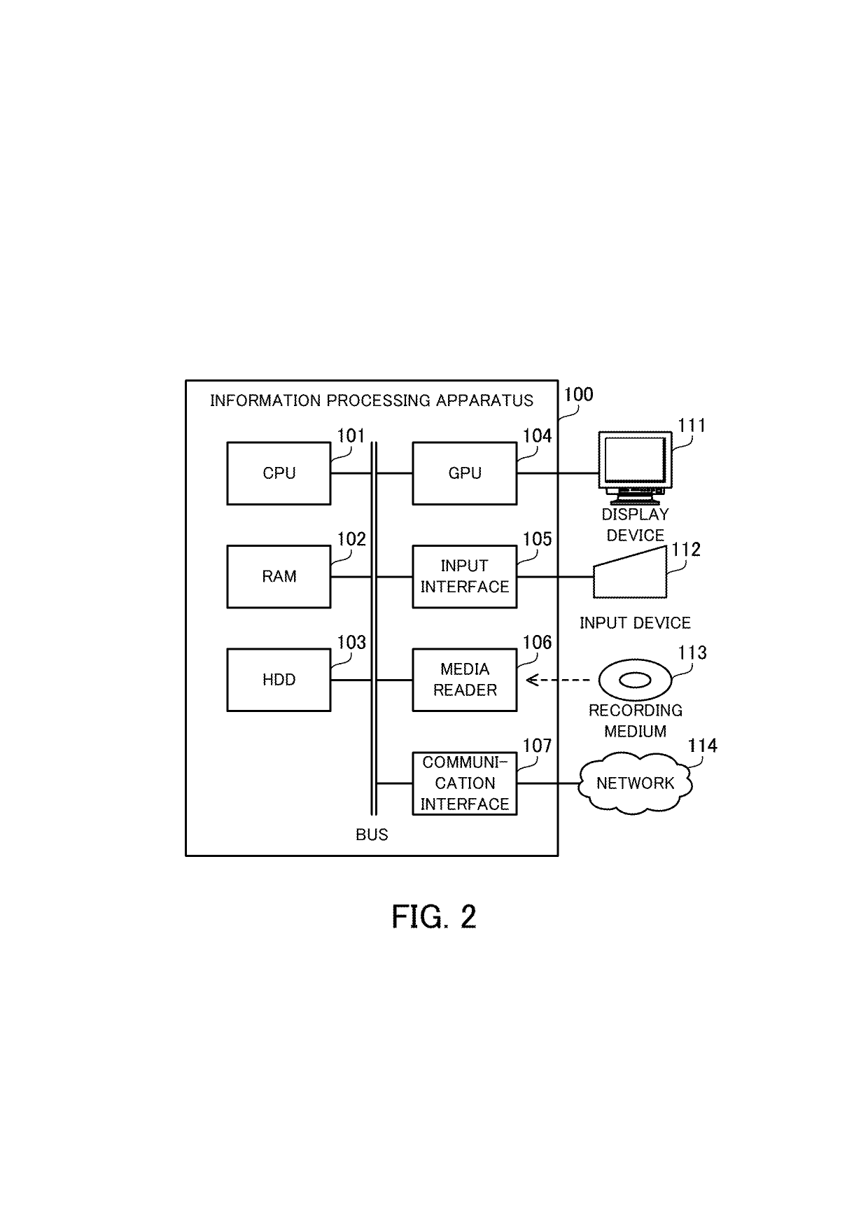

FIG. 2 is a diagram illustrating a hardware example of an information processing apparatus according to a second embodiment. An information processing apparatus 100 according to the second embodiment supports failure handling work when a failure occurs in an information processing system. The information processing system includes various kinds of devices such as a server computer, a storage device, and a communication device. Each of these devices outputs a log file corresponding to its type or the type of software executed on it. The engineer who performs the failure handling work searches the log files for an important part relating to a failure. The information processing apparatus 100 corresponds to the information processing apparatus 10 according to the first embodiment.

The information processing apparatus 100 includes a CPU 101, a RAM 102, an HDD 103, a GPU 104, an input interface 105, a media reader 106, and a communication interface 107. The CPU 101 corresponds to the processing unit 12 according to the first embodiment. The RAM 102 or the HDD 103 corresponds to the storage unit 11 according to the first embodiment.

The CPU 101 is a processor that executes program commands. The CPU 101 loads a program and data from the HDD 103 into the RAM 102, and executes the program. The information processing apparatus 100 may include a plurality of processors.

The RAM 102 is a volatile semiconductor memory that temporarily stores a program executed by the CPU 101 and data used for calculation by the CPU 101. The information processing apparatus 100 may include a volatile memory of a type other than the RAM.

The HDD 103 is a nonvolatile storage that stores software programs such as an operating system, middleware, and application software, and data. The information processing apparatus 100 may include another type of non-volatile storage such as an SSD or a flash memory.

The GPU 104 performs image processing in cooperation with the CPU 101, and outputs an image to a display device 111 connected to the information processing apparatus 100. The display device 111 is, for example, a cathode ray tube (CRT) display, a liquid crystal display, an organic electro luminescence (EL) display, or a projector.

The GPU 104 may be used as a general purpose computing on graphics processing unit (GPGPU). The GPU 104 is able to execute a program in accordance with a command from the CPU 101. The information processing apparatus 100 may include, as a GPU memory, a volatile semiconductor memory other than the RAM 102.

The input interface 105 receives an input signal from an input device 112 connected to the information processing apparatus 100. The input device 112 is, for example, a mouse, a touch panel, or a keyboard. A plurality of input devices may be connected to the information processing apparatus 100.

The media reader 106 is a reading device that reads out a program and data recorded in a recording medium 113. The recording medium 113 is, for example, a magnetic disk, an optical disc, or a semiconductor memory. Examples of the magnetic disk include a flexible disk (FD) and an HDD. Examples of the optical disc include a compact disc (CD) and a digital versatile disc (DVD). The media reader 106 copies a program and data read from the recording medium 113 to another recording medium such as the RAM 102 or the HDD 103. The read program may be executed by the CPU 101.

The recording medium 113 may be a portable recording medium. The recording medium 113 may be used for distribution of programs and data. The recording medium 113 and the HDD 103 may be referred to as a computer-readable recording medium.

The communication interface 107 communicates with other information processing apparatuses via a network 114. The communication interface 107 may be a wired communication interface connected to a wired communication device such as a switch or a router, or may be a wireless communication interface connected to a wireless communication device such as a base station or an access point.

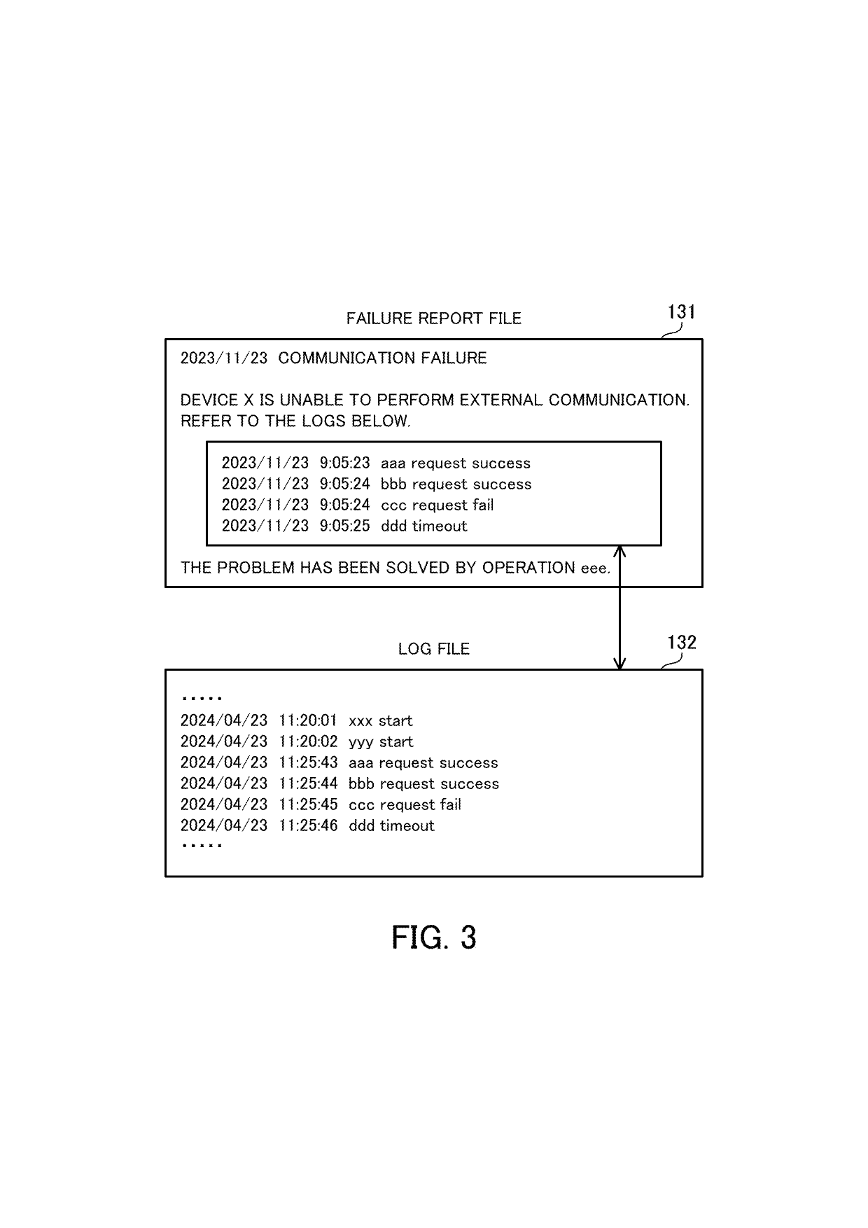

FIG. 3 is a diagram illustrating an example of a failure report file and a log file. The information processing apparatus 100 accumulates a plurality of failure report files including a failure report file 131 in a database. The failure report file 131 indicates failure handling work for one past failure. Normally, the failure report file 131 is a text file written in a natural language.

The failure report file 131 includes date and time of occurrence of a failure. The failure report file 131 includes the content of the failure such as a communication error and the content of the work performed to resolve the failure. Further, the failure report file 131 includes a partial log determined to be an important part relating to the failure among the logs included in the log file at the time of occurrence of the failure. Normally, the partial log included in the failure report file 131 is text data extracted from the log file. However, the partial log may be image data obtained by capturing a part of the log file.

When a new failure is detected, an engineer who manages the information processing system searches a plurality of log files including the log file 132 for an important part relating to the failure. The log file 132 is the latest log file stored at the time of the failure handling work, and includes logs from the time of the failure handling work to at least a certain time before that.

Each component of the information processing system outputs a log file. For example, an authentication process on the server computer outputs an authentication log. For example, a database management process on the server computer outputs a database access log. For example, a communication process or a communication device on the server computer outputs a communication log.

The log files of different types of components may be written in different formats. The log file 132 chronologically includes a plurality of records, and in each record, an event occurrence time and an event content are associated with each other. An event indicates, for example, activation of a process, success in processing a request, failure in processing a request, timeout, or the like.

The engineer who performs the failure handling work extracts an important log indicating an important part relating to the current failure from the log file 132. The information processing apparatus 100 according to the second embodiment supports extraction of an important log from the log file 132. The information processing apparatus 100 estimates a log similar to the past partial log included in the failure report file 131 as an important log, and presents the estimated important log to the engineer.

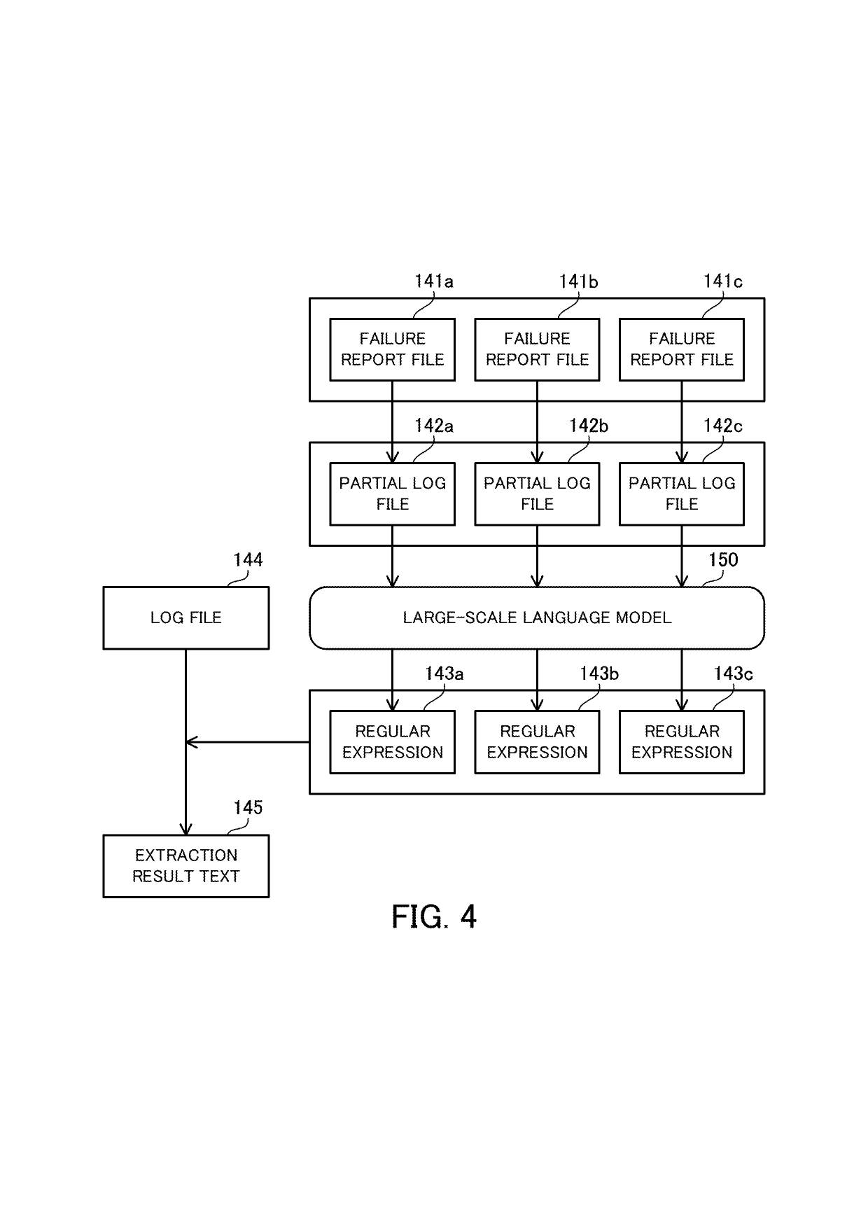

FIG. 4 is a diagram illustrating an example of a flow of extraction of an important log by using a large-scale language model. The information processing apparatus 100 uses a large-scale language model 150 to extract important logs. The large-scale language model 150 is a machine learning model trained by using large-scale training data, and is a natural language processing model that generates an output text from an input text. The large-scale language model 150 is an interactive model that outputs a character string according to an instruction included in an input text.

The large-scale language model 150 may be trained by the information processing apparatus 100 or may be trained by another information processing apparatus. The large-scale language model 150 may be stored in the information processing apparatus 100 or in another information processing apparatus. Another information processing apparatus may provide a text generation service using the large-scale language model 150. The information processing apparatus 100 may transmit an input text to another information processing apparatus and may receive an output text corresponding to the input text from this another information processing apparatus.

The information processing apparatus 100 reads out the failure report files 141a, 141b, and 141c from a failure report database. The information processing apparatus 100 extracts a partial log quoted by the failure report file 141a from the failure report file 141a, and generates a partial log file 142a indicating the extracted partial log. Similarly, the information processing apparatus 100 extracts a partial log from the failure report file 141b to generate a partial log file 142b, and extracts a partial log from the failure report file 141c to generate a partial log file 142c.

However, when the partial logs have already been separated and accumulated, the information processing apparatus 100 may omit the extraction of the partial logs. When a partial log included in a failure report file is image data, the information processing apparatus 100 converts the image data into text data by using a character recognition technique. The information processing apparatus 100 may convert the image data into the text data by using an image recognition model, which is a trained machine learning model. When the large-scale language model 150 has a character recognition function, the information processing apparatus 100 may convert the image data into the text data by using this large-scale language model 150.

The information processing apparatus 100 generates an input text including the partial log indicated by the partial log file 142a, and enters the input text to the large-scale language model 150. The input text further includes an instruction, which may be referred to as a prompt. The instruction instructs generation of a regular expression for searching for a character string similar to a specified partial log. As a result, the large-scale language model 150 outputs a regular expression 143a as the output text. The information processing apparatus 100 stores the output regular expression 143a.

Similarly, the information processing apparatus 100 generates an input text including the partial log indicated by the partial log file 142b, and enters the input text to the large-scale language model 150. The information processing apparatus 100 stores a regular expression 143b output by the large-scale language model 150. The information processing apparatus 100 generates an input text including the partial log indicated by the partial log file 142c, and enters the input text to the large-scale language model 150. The information processing apparatus 100 stores a regular expression 143c output by the large-scale language model 150.

When a failure is detected, the information processing apparatus 100 acquires a latest log file 144. The regular expressions 143a, 143b, and 143c may be generated and stored before the failure detection or may be generated after the failure detection. The information processing apparatus 100 searches the log file 144 for a character string corresponding to the regular expression 143a by executing the regular expression 143a on the log file 144. If the corresponding character string is detected, the information processing apparatus 100 extracts the character string, and adds the character string to an extraction result text 145.

Similarly, the information processing apparatus 100 searches the log file 144 for a character string corresponding to the regular expression 143b. If the corresponding character string is detected, the information processing apparatus 100 extracts the character string, and adds the character string to the extraction result text 145. The information processing apparatus 100 searches the log file 144 for a character string corresponding to the regular expression 143c. If the corresponding character string is detected, the information processing apparatus 100 extracts the character string, and adds the character string to the extraction result text 145. The information processing apparatus 100 outputs the extraction result text 145 to the engineer who performs the failure handling work.

As described above, the information processing apparatus 100 reads out, from a failure report database, a plurality of partial logs determined to be important parts in past failures. The information processing apparatus 100 generates a plurality of regular expressions from the plurality of partial logs by using the large-scale language model 150. The information processing apparatus 100 searches for character strings, each of which corresponds to one of the plurality of regular expressions, from the current failure log.

The information processing apparatus 100 is able to execute the regular expressions 143a, 143b, and 143c on log files other than the log file 144 about the current failure. The information processing apparatus 100 is able to reuse the regular expressions 143a, 143b, and 143c for the next and subsequent failures. The information processing apparatus 100 may generate a regular expression by integrating the regular expressions 143a, 143b, and 143c. For example, the information processing apparatus 100 may generate a combined regular expression by combining the regular expressions 143a, 143b, and 143c by a logical sum, and may execute the combined regular expression on the log file 144.

The large-scale language model 150 may be a neural network and may be implemented using a transformer having an attention mechanism. The transformer is described in the following non-patent literature. Ashish Vaswani, Noam Shazeer, Niki Parmar, Jakob Uszkoreit, Llion Jones, Aidan N. Gomez, and Lukasz Kaiser, "Attention Is All You Need", Proc. of the 31st International Conference on Neural Information Processing Systems (NIPS 2017), pages 6000-6010, December 2017. An example of the structure of the large-scale language model 150 will be described below.

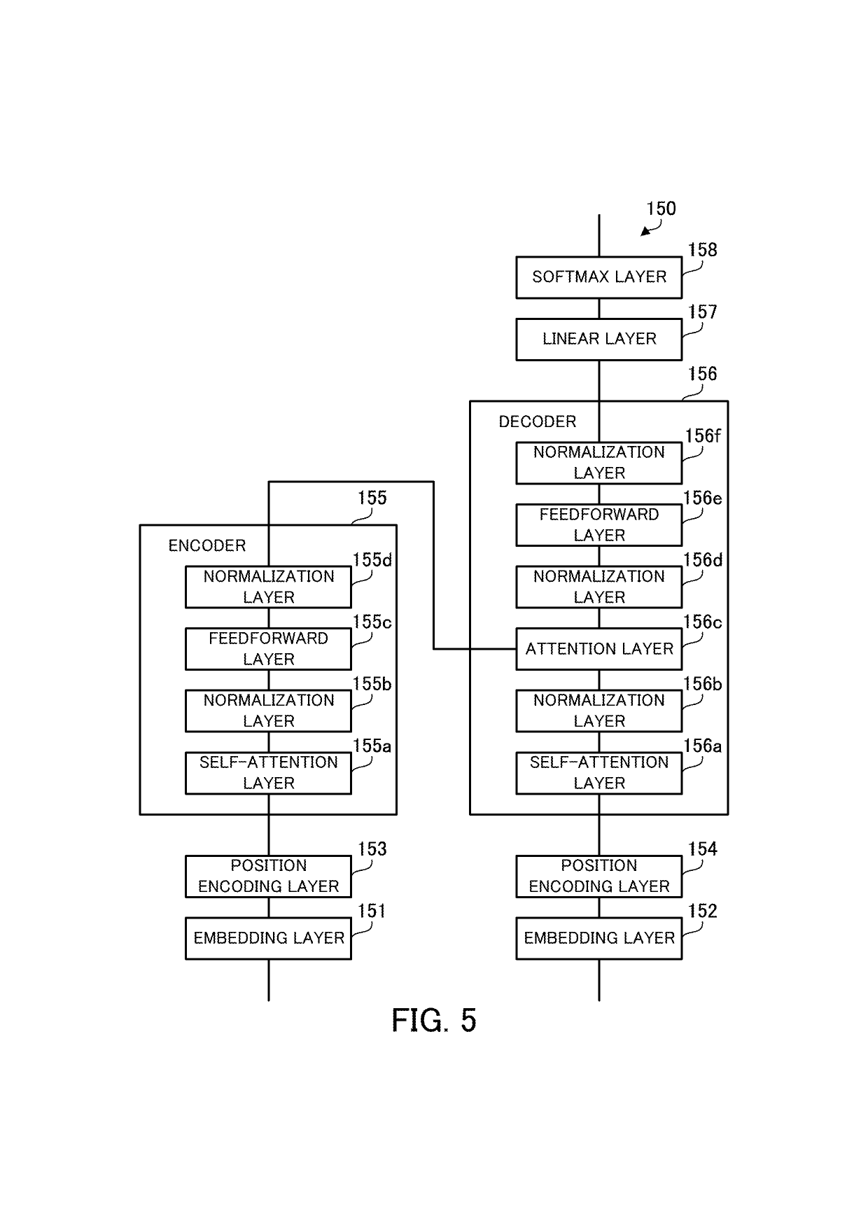

FIG. 5 is a diagram illustrating an example of the structure of the large-scale language model. The large-scale language model 150 is an encoder-decoder neural network. The large-scale language model 150 includes embedding layers 151 and 152, position encoding layers 153 and 154, an encoder 155, a decoder 156, a linear layer 157, and a softmax layer 158.

The embedding layer 151 converts an individual word included in the input text into a word vector called an embedded representation or a distributed representation. The word vector is a numerical vector having a certain number of dimensions such as 512 dimensions or 1024 dimensions. Similar word vectors are assigned to words used in similar contexts. The correspondence between a word and a word vector is determined by the neural network. The embedding layer 151 may be trained with other layers of the large-scale language model 150 or may be trained in advance.

The embedding layer 152 converts each of one or more words determined so far among words to be included in the output text into a word vector. In the large-scale language model 150, the words to be included in the output text are determined one by one sequentially from the beginning. The correspondence between a word and a word vector is the same as that in the embedding layer 151.

The position encoding layer 153 adds, to a word vector output by the embedding layer 151, a position vector based on the position of the corresponding word. The addition of the position vector may be referred to as position encoding. The position vector is a numerical vector having the same number of dimensions as the word vector. For each of the plurality of words included in the input text, the position encoding layer 153 calculates a numerical value of the dimension included in the corresponding position vector by using a sine function or a cosine function from a non-negative integer indicating the ordinal number of the word from the beginning.

The position encoding layer 154 adds, to a word vector output by the embedding layer 152, a position vector based on the position of the corresponding word. The method of calculating the position vector is the same as that of the position encoding layer 153. For each of one or more words included in the output text, the position encoding layer 154 calculates a numerical value of the dimension included in the corresponding position vector using a sine function or a cosine function from a non-negative integer indicating the ordinal number of the word from the beginning.

The encoder 155 converts a plurality of vectors corresponding to a plurality of words. The encoder 155 includes a self-attention layer 155a, a normalization layer 155b, a feedforward layer 155c, and a normalization layer 155d in this order. In the large-scale language model 150, a plurality of encoders 155 may be stacked in series. In that case, the first encoder receives vectors from the position encoding layer 153, and the last encoder outputs vectors to the decoder 156.

The self-attention layer 155a converts a vector by using an attention mechanism. The self-attention layer 155a has a query matrix, a key matrix, and a value matrix as trained parameter values. The self-attention layer 155a selects one target word from a plurality of words included in the input text.

The self-attention layer 155a converts the vector of the target word by the query matrix, to calculate a vector called a query. In addition, the self-attention layer 155a converts the vectors of the plurality of words by the key matrix, to calculate vectors called keys. The self-attention layer 155a calculates the inner product of the query and the individual key as the attention score of the corresponding word. The attention score indicates the degree of relevance between the target word and each word.

The self-attention layer 155a converts each of the vectors of the plurality of words by the value matrix, to calculate a vector called a value. The self-attention layer 155a calculates a weighted sum of values between a plurality of words by using an attention score as a weight, and outputs the calculated weighted sum as a converted vector for the target word. The self-attention layer 155a repeats the above processing while changing the target word.

The normalization layer 155b normalizes the vectors output by the self-attention layer 155a so that the numerical value of each dimension follows a certain distribution. The feedforward layer 155c is a forward neural network. The feedforward layer 155c converts the vectors of the plurality of words individually by using trained parameter values. The normalization layer 155d normalizes the vectors output by the feedforward layer 155c in the same manner as the normalization layer 155b.

The decoder 156 converts the vector of one or more words determined so far among the words to be included in the output text. The decoder 156 includes a self-attention layer 156a, a normalization layer 156b, an attention layer 156c, a normalization layer 156d, a feedforward layer 156e, and a normalization layer 156f in this order. In the large-scale language model 150, a plurality of decoders 156 may be stacked in series. In that case, the first decoder receives vectors from the position encoding layer 154, and the last encoder outputs vectors to the linear layer 157.

The self-attention layer 156a converts a vector by using an attention mechanism similar to that of the self-attention layer 155a. The query, key and value are computed from the vectors of the words in the output text. The normalization layer 156b normalizes the vectors output by the self-attention layer 156a in the same manner as the normalization layer 155b.

The attention layer 156c converts the vectors of the words in the output text by using an attention mechanism. However, the attention layer 156c calculates the query from the vectors of the words in the output text, and calculates the key and the value from the vectors of the words in the input text. In this way, the degree of relevance between the words in the output text and the words in the input text is determined.

The attention layer 156c selects one target word from one or more words included in the output text. The attention layer 156c converts the vector of the target word by the query matrix, to calculate a query. In addition, the attention layer 156c receives the vectors of the plurality of words included in the input text from the encoder 155. The attention layer 156c converts the vector of each word by the key matrix, to calculate a key, and converts the vector of each word by the value matrix, to calculate a value.

The attention layer 156c calculates the inner product of the query and the key as the attention score, for each word in the input text. The attention score indicates the degree of relevance between the target word in the output text and each word in the input text. The attention layer 156c calculates a weighted sum of values among a plurality of words in the input text by using the attention score as a weight. The attention layer 156c outputs the calculated weighted sum as a converted vector for the target word in the output text.

The normalization layer 156d normalizes the vectors output by the attention layer 156c in the same manner as the normalization layer 155b. The feedforward layer 156e converts the vectors of the words in the output text individually by using trained parameter values. The normalization layer 156f normalizes the vectors output by the feedforward layer 156e in the same manner as the normalization layer 155b.

The linear layer 157 calculates scores for various words described in a dictionary by using numerical values included in the vectors output by the decoder 156. The words described in the dictionary are words to which word vectors have been assigned by the embedding layers 151 and 152. For the calculation of the scores, for example, the word vectors of the embedding layers 151 and 152 are referred to.

The softmax layer 158 converts the scores of various words into probabilities between 0 and 1. For example, the large-scale language model 150 selects a word having the highest probability and adds the selected word to the end in the output text. The large-scale language model 150 generates the output text by repeating the processing of the decoder 156 described above. Next, input and output examples of the large-scale language model 150 when a regular expression is generated by using the large-scale language model 150 will be described.

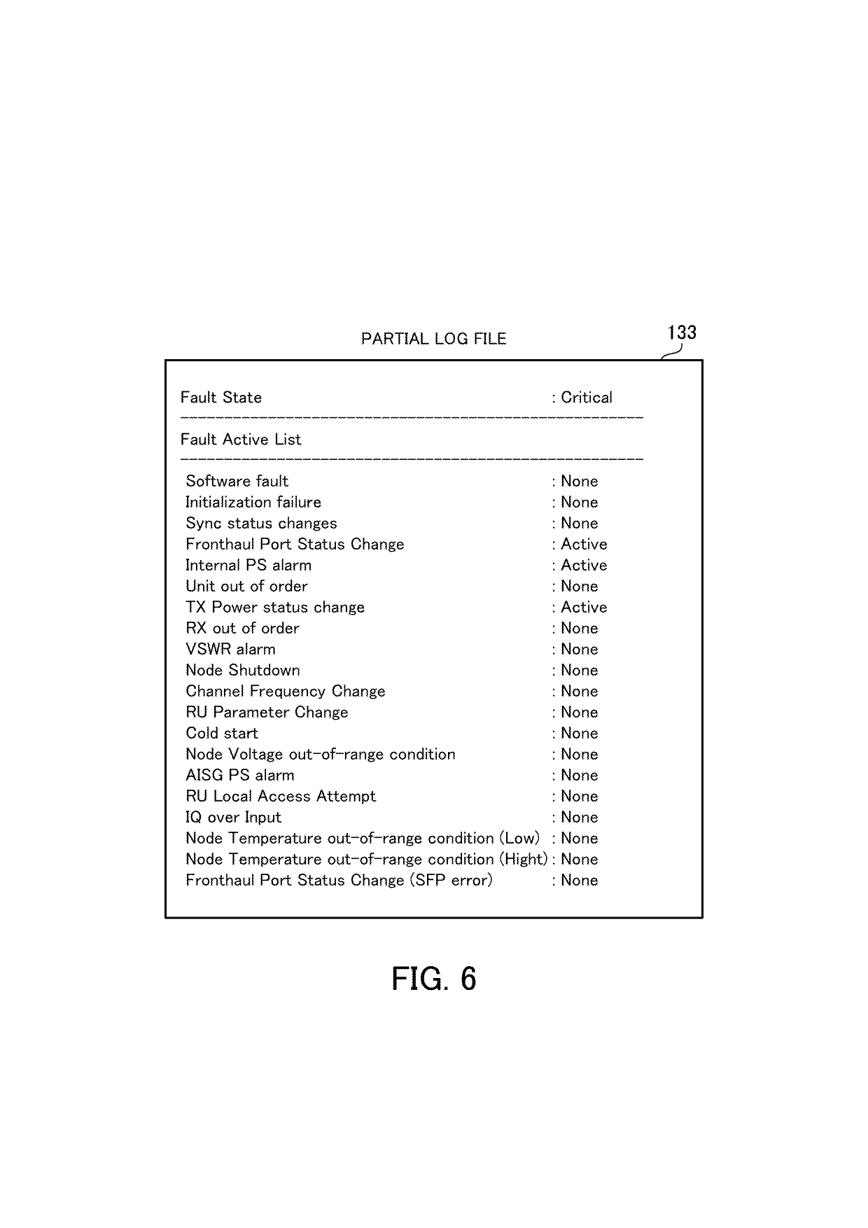

FIG. 6 is a diagram illustrating an example of a partial log file. A partial log file 133 indicates a partial log included in a failure report file. This partial log is a partial log that has been extracted from a log file, as an important part by an engineer in the past.

The partial log file 133 sequentially includes a row including a heading “Fault State”, a row including 63 hyphens, a row including a heading “Fault Active List”, and a row including 63 hyphens. Following this, the partial log file 133 includes a plurality of rows indicating sets of item names and states.

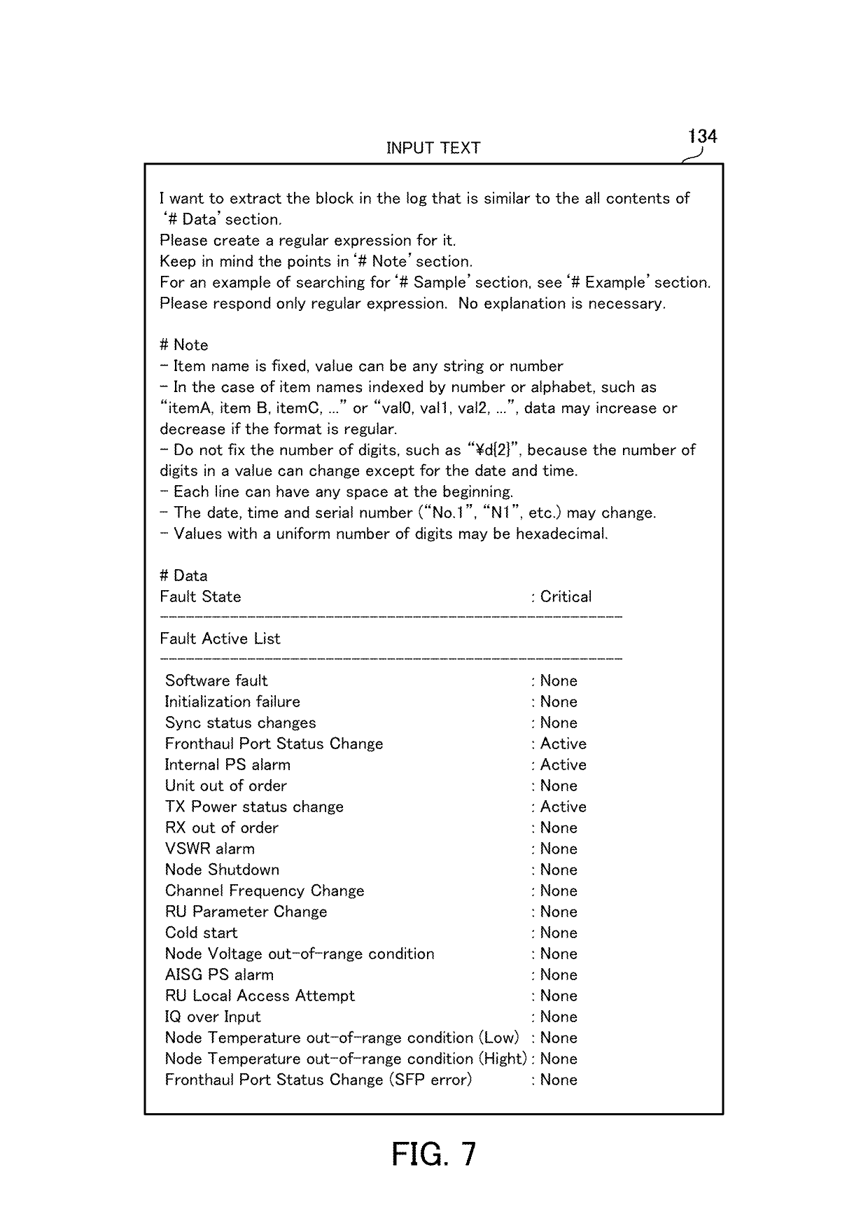

FIG. 7 is a diagram illustrating an example of an input text. The information processing apparatus 100 generates an input text 134 from the partial log file 133. The input text 134 is entered to the large-scale language model 150. The input text 134 includes instruction, note, and data. The data is the partial log itself included in the partial log file 133.

The instruction indicates that the user wishes extraction of a block similar to specified data from a log, and indicates generation of a regular expression for executing the extraction. In addition, the instruction indicates that the specified note needs to be followed, only a regular expression need to be output, and no explanation is needed. In addition, the instruction indicates that a sample of a block and a generation example of a regular expression for extracting the block need to be referred to. The sample and generation example will be described later. The instruction may be fixed phrases common to input texts generated from various partial log files.

The note indicates conditions on the generated regular expression in order to prevent the regular expression from becoming excessively specific and losing versatility. The note may be a general note based on properties common to various logs, or may be fixed phrases common to input texts generated from various partial log files.

For example, the note indicates that the item names are fixed while the item values are variable and are character strings or numerical values. The note indicates that when a plurality of item names are indexed by numbers or alphabets, these items are arranged in ascending order or descending order. The note indicates that the number of digits of an individual numerical value is not fixed, except for the date and time, that the date and time and the identification numbers are variable, and that the numerical values may be expressed in hexadecimal. The note indicates that a blank (space) may be inserted at the beginning of each line.

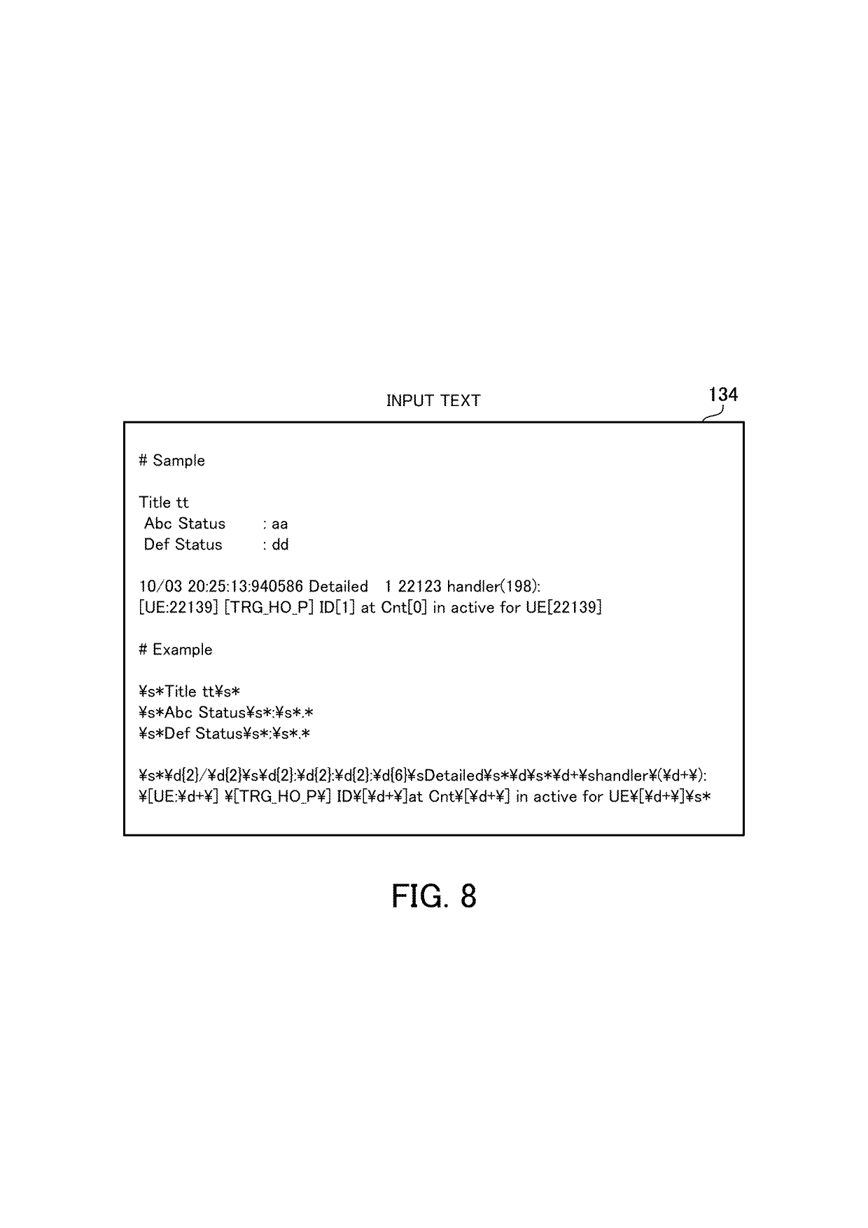

FIG. 8 is the second half of the diagram illustrating the example of the input text. As described above, the input text 134 further includes a sample of a block and a generation example of a regular expression for extracting the block. The sample and generation example may be fixed phrases commonly used in the input text generated from various partial log files. When the large-scale language model 150 is able to inherit the context among a plurality of input texts, the sample and generation example of the second and subsequent input texts may be omitted. In addition, there are cases where the large-scale language model 150 is able to generate an appropriate regular expression even if a sample and a generation example are not entered. In that case, the input text 134 may be generated without a sample and a generation example.

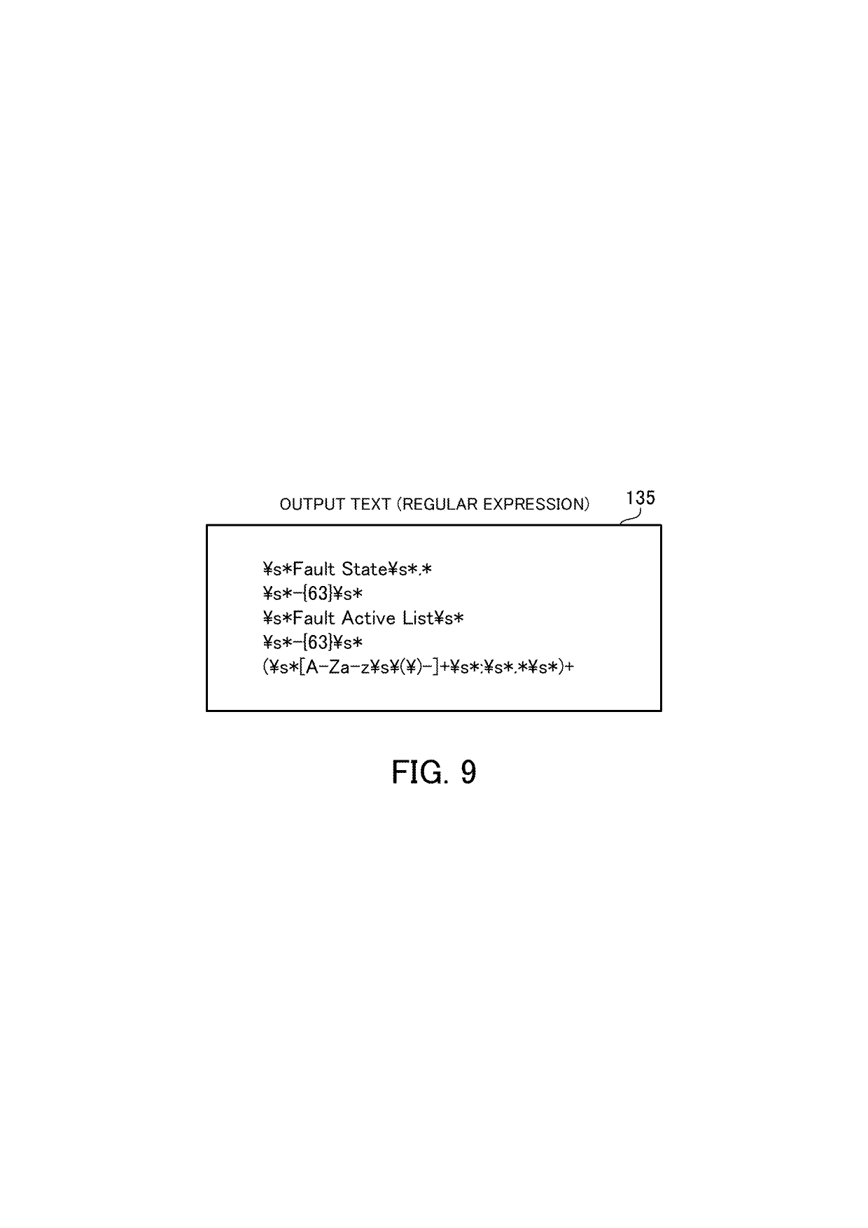

FIG. 9 is a diagram illustrating an example of an output text. The large-scale language model 150 generates an output text 135 from the input text 134. Since the input text 134 instructs to output only a regular expression, the output text 135 is output as a regular expression.

The output text 135 defines a regular expression for searching for a character string satisfying the following conditions. In the first line, a character string “Fault State” is written after zero or more spaces, and an arbitrary character string may be written with zero or more spaces after “Fault State”. In the second line, 63 hyphens are written after zero or more spaces, and an arbitrary number of spaces may follow thereafter. In the third line, a character string “Fault Active List” is written after zero or more spaces, and an arbitrary number of spaces may follow thereafter.

In the fourth line, 63 hyphens are written after zero or more spaces, and an arbitrary number of spaces may follow thereafter. One or more rows satisfying the following conditions continue from the fifth row. Therefore, the number of lines of character strings corresponding to this regular expression is variable. After zero or more spaces, a character string of one or more characters using an alphabet, a space, parentheses, and a hyphen is written. Further, a colon is written with zero or more spaces interposed therebetween. Furthermore, an arbitrary character string may be written with zero or more spaces interposed therebetween, and an arbitrary number of spaces may follow thereafter.

As described above, once a regular expression is generated from a failure report database, the information processing apparatus 100 is able to extract an important log by executing the regular expression in the subsequent failure handling work. Therefore, the information processing apparatus 100 is able to efficiently extract important logs.

For example, assuming that 100 partial logs are included in the failure report database, that one response time of the large-scale language model 150 is 1 minute on average, and that the execution time of one regular expression is one second, according to the second embodiment, important logs are extracted in about 100 seconds by generating the regular expression in advance. On the other hand, in a method in which the large-scale language model 150 is configured to directly extract a part similar to a partial log, it takes about 100 minutes to extract important logs. As described above, in the second embodiment, the execution time of important log extraction is greatly shortened. Next, functions and a processing procedure of the information processing apparatus 100 will be described.

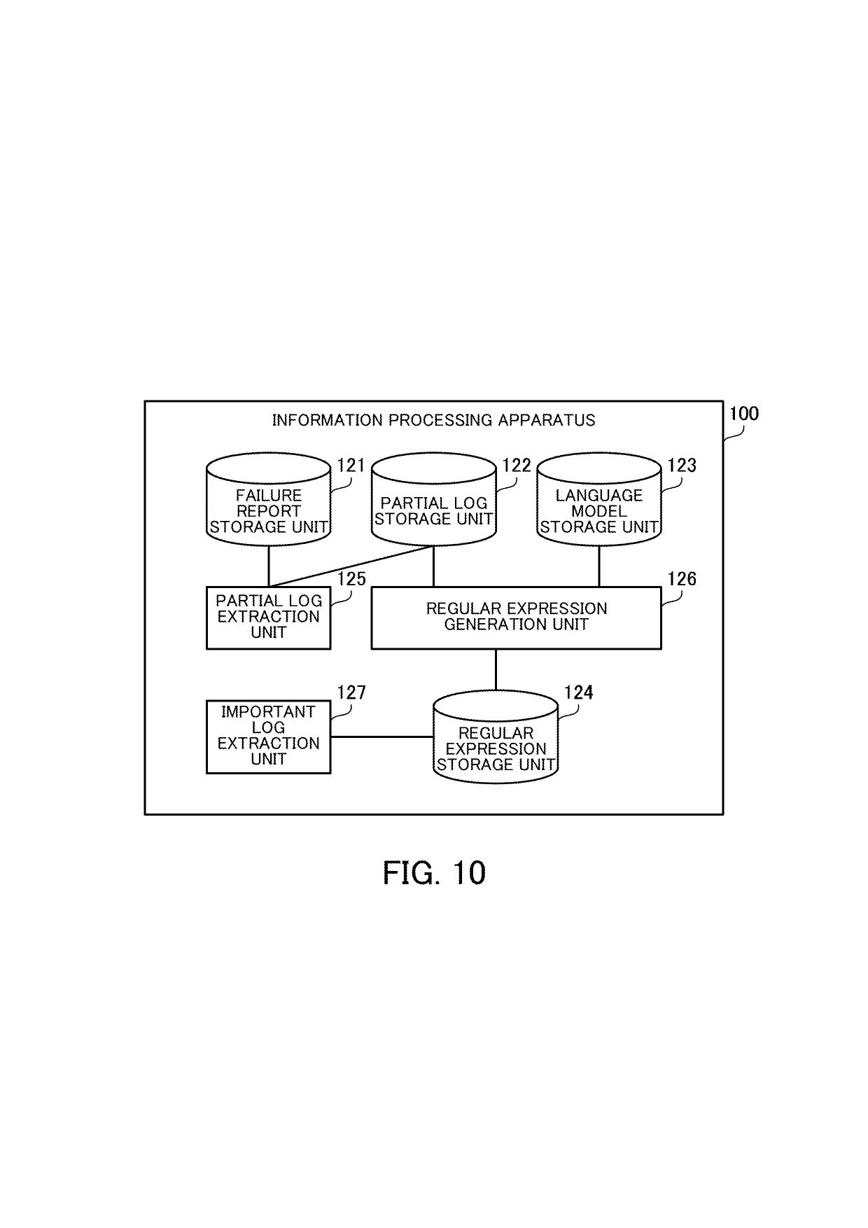

FIG. 10 is a block diagram illustrating a functional example of the information processing apparatus. The information processing apparatus 100 includes a failure report storage unit 121, a partial log storage unit 122, a language model storage unit 123, a regular expression storage unit 124, a partial log extraction unit 125, a regular expression generation unit 126, and an important log extraction unit 127. The failure report storage unit 121, the partial log storage unit 122, the language model storage unit 123, and the regular expression storage unit 124 are implemented using, for example, the RAM 102 or the HDD 103. The partial log extraction unit 125, the regular expression generation unit 126, and the important log extraction unit 127 are implemented using, for example, the CPU 101 and a program.

The failure report storage unit 121 is a database that stores a plurality of failure report files such as the failure report files 131, 141a, 141b, and 141c. Every time a failure occurs, a new failure report file is created and stored in the failure report storage unit 121. The failure report database may be provided outside the information processing apparatus 100.

The partial log storage unit 122 is a database that stores a plurality of partial log files such as the partial log files 133, 142a, 142b, and 142c. A partial log file may be stored in the partial log storage unit 122 every time a failure occurs. Alternatively, a plurality of partial log files may be collectively generated by batch processing from a failure report database at a certain point in time. The partial log database may be provided outside the information processing apparatus 100.

The language model storage unit 123 stores the large-scale language model 150. However, the large-scale language model 150 may be stored outside the information processing apparatus 100. The regular expression storage unit 124 stores a plurality of regular expressions corresponding to a plurality of partial log files. However, a plurality of regular expressions may be integrated into one or a small number of regular expressions.

The partial log extraction unit 125 reads out a failure report file from the failure report storage unit 121, and extracts a partial log included in the failure report file. When the data format of the partial log included in the failure report file is an image format, the partial log extraction unit 125 converts the image data into text data by using a character recognition model. The partial log extraction unit 125 generates a partial log file including the extracted partial log, and stores the partial log file in the partial log storage unit 122.

The regular expression generation unit 126 reads out the partial log file from the partial log storage unit 122, and generates an input text including the partial log included in the partial log file and fixed phrases such as instruction or note. The fixed phrases are entered to the information processing apparatus 100 in advance, for example. The regular expression generation unit 126 enters the input text to the large-scale language model 150, and acquires an output text corresponding to the input text from the large-scale language model 150. The regular expression generation unit 126 stores the regular expression, which constitutes the output text, in the regular expression storage unit 124.

The important log extraction unit 127 receives one or more log files at the time of failure occurrence. The important log extraction unit 127 executes a plurality of regular expressions stored in the regular expression storage unit 124 on each of the received log files, and searches for important logs corresponding to the regular expressions. The important log extraction unit 127 extracts a detected important log from a log file, and outputs an extraction result text including one or more important logs. The important log extraction unit 127 may store the extraction result text in a nonvolatile storage such as the HDD 103, may display the extraction result text on the display device 111, or may transmit the extraction result text to another information processing apparatus.

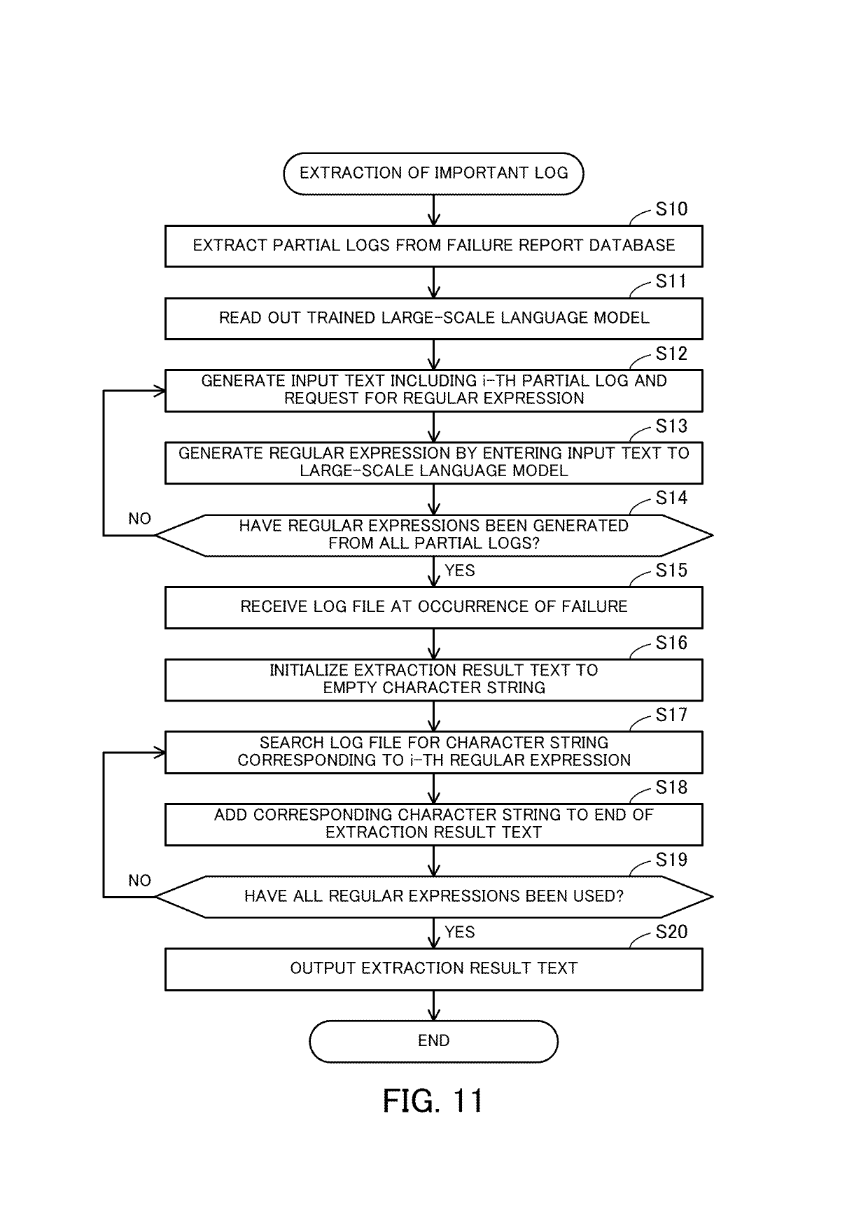

FIG. 11 is a flowchart illustrating an example of a procedure of extraction of an important log. In step S10, the partial log extraction unit 125 extracts a plurality of partial logs from a plurality of failure report files stored in the failure report database. Typically, one partial log is extracted from one failure report file. However, there may be a failure report file that does not include a partial log, or there may be a failure report file that includes two or more partial logs. When a partial log database already exists, step S10 may be omitted.

In step S11, the regular expression generation unit 126 reads out the trained large-scale language model 150. Alternatively, the regular expression generation unit 126 accesses another information processing apparatus that provides a service using the large-scale language model 150. In step S12, the regular expression generation unit 126 generates an input text including an i-th partial log (i = 1, 2, ...) among the plurality of partial logs extracted in step S10 and including an instruction requesting a regular expression.

In step S13, the regular expression generation unit 126 enters the input text to the large-scale language model 150 to cause the large-scale language model 150 to generate a regular expression capable of searching for a character string similar to the partial log. In step S14, the regular expression generation unit 126 determines whether regular expressions have been generated from all the partial logs extracted in step S10. If regular expressions have been generated from all the partial logs, the process proceeds to step S15. If there is a partial log for which a regular expression has not been generated, the process returns to step S12. Steps S10 to S14 may be executed in advance before a new failure occurs.

In step S15, the important log extraction unit 127 receives a log file at the time of occurrence of a failure. In step S16, the important log extraction unit 127 initializes an extraction result text to an empty character string. In step S17, the important log extraction unit 127 searches the log file received in step S15 for a character string corresponding to the i-th regular expression (i = 1, 2, ...) among the plurality of regular expressions generated in step S13.

In step S18, if a character string corresponding to the regular expression is detected, the important log extraction unit 127 extracts the corresponding character string from the log file. The important log extraction unit 127 adds the extracted character string to the end of the extraction result text. In step S19, the important log extraction unit 127 determines whether all the regular expressions generated in step S13 have been used. If all the regular expressions have been used, the process proceeds to step S20. If there is an unused regular expression, the process returns to step S17. In step S20, the important log extraction unit 127 outputs the extraction result text as a response to the log file.

As described above, the information processing apparatus 100 according to the second embodiment automatically extracts an important log that probably relates to a failure from a log file output by the information processing system. Thus, the information processing apparatus 100 is able to execute the failure handling work more efficiently. Further, the information processing apparatus 100 extracts, from the current log file, a character string similar to a partial log manually extracted in past failure handling work. Accordingly, the important log extraction accuracy is improved.

The information processing apparatus 100 causes the large-scale language model 150 to generate regular expressions based on past partial logs, and executes the generated regular expressions on the current log file. As a result, there is no need to manually create a program for important log extraction, and the burden of programming is reduced. In addition, the information processing apparatus 100 does not need to call the large-scale language model 150 for each failure, and is able to extract important logs from log files at high speed.

The information processing apparatus 100 uses the generalization capability of the large-scale language model 150 to generate highly versatile regular expressions that do not depend on event-specific character strings, such as date and time of events or identifiers of devices included in partial logs. Accordingly, the important log extraction accuracy is improved.

In one aspect, useful parts are efficiently extracted from log data.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring first partial log data extracted from first log data output by an information processing system; and
generating, by entering the first partial log data to a trained machine learning model, a search program for searching second log data for second partial log data having a common pattern with the first partial log data by using the machine learning model.

2. The non-transitory computer-readable recording medium according to claim 1, wherein the search program includes a regular expression indicating the pattern.

3. The non-transitory computer-readable recording medium according to claim 1,
wherein the machine learning model is a natural language processing model for generating an output text from an input text, and
wherein the generating includes entering the first partial log data and an instruction instructing generation of the search program to the machine learning model and causing the machine learning model to output the search program.

4. The non-transitory computer-readable recording medium according to claim 3, wherein the generating further includes entering, to the machine learning model, sample data in which third partial log data is associated with another search program capable of searching for the third partial log data.

5. The non-transitory computer-readable recording medium according to claim 1, wherein the first partial log data is a part of the first log data, the part being quoted by failure report data indicating a failure in the information processing system.

6. The non-transitory computer-readable recording medium according to claim 1, wherein the process further includes executing the search program on the second log data and extracting the second partial log data from the second log data.

7. A generation method comprising:
acquiring, by a processor, first partial log data extracted from first log data output by an information processing system; and
generating, by the processor, by entering the first partial log data to a trained machine learning model, a search program for searching second log data for second partial log data having a common pattern with the first partial log data by using the machine learning model.

8. An information processing apparatus comprising:
a memory configured to store first partial log data extracted from first log data output by an information processing system; and
a processor coupled to the memory and the processor configured to generate, by entering the first partial log data to a trained machine learning model, a search program for searching second log data for second partial log data having a common pattern with the first partial log data by using the machine learning model.
